(19) United States
(12) Patent Application Publication
(10) Pub. No.: US 2017/0115806 A1
(43) Pub. Date: Apr. 27, 2017

(54) DISPLAY TERMINAL DEVICE, DISPLAY CONTROL METHOD, AND COMPUTER-READABLE RECORDING MEDIUM

(71) Applicant: FUJITSU LIMITED, Kawasaki-shi (JP)

(72) Inventors: MASANORI ISOBE, Ota (JP); Shinichi Tashiro, Narashino (JP); Shintaro Kida, Kawasaki (JP); Aiko Koyago, Ota (JP); Tsuyoshi UNO, Funabashi (JP)

(73) Assignee: FUJITSU LIMITED, Kawasaki-shi (JP)

(21) Appl. No.: 15/276,939

(22) Filed: Sep. 27, 2016

(30) Foreign Application Priority Data
Oct. 23, 2015 (JP) 2015-209393

(51) Int. Cl. G06F 3/041; G06F 3/046; G06F 3/0354; G06F 3/044

(52) U.S. Cl. CPC G06F 3/0416; G06F 3/044; G06F 3/046; G06F 3/0412; G06F 3/03545; G06F 2203/04106; G06F 3/0484

(57) ABSTRACT

A tablet terminal has a touch panel. The tablet terminal moves a display position of a displayed object or switching a displayed object, according to a predetermined operation performed on a touch panel. The tablet terminal detects approach of an input device. The tablet terminal restricts the moving the display position of the displayed object or the switching the displayed object when the approach of the input device is detected.

### CROSS-REFERENCE TO RELATED APPLICATION

This application is based upon and claims the benefit of priority of the prior Japanese Patent Application No. 2015-209393, filed on Oct. 23, 2015, the entire contents of which are incorporated herein by reference.

### FIELD

The embodiments discussed herein are related to a display terminal device, a display control method, and a display control program.

### BACKGROUND

There have been used electronic devices such as cell-phones and tablet terminals that have a touch panel. Such electronic devices allow a user to perform a screen operation on a touch panel thereof with a touch pen or his/her finger(s). For example, these electronic devices have two operation modes, and switch between the two operation modes when a predesignated button or the like has been clicked and perform various processes, such as the input of a character and the scaling of a screen.

Patent Literature 1: Japanese Laid-open Patent Publication No. 2007-233649

### SUMMARY

According to an aspect of an embodiment, a display terminal device includes a processor that executes a process. A process includes moving a display position of a displayed object or switching a displayed object, according to a predetermined operation performed on a touch panel; detecting approach of an input device; and restricting the moving the display position of the displayed object or the switching the displayed object when the approach of the input device is detected at the detecting.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a tablet terminal according to a first embodiment;

FIG. 2 is a functional block diagram depicting a functional configuration example of the tablet terminal according to the first embodiment;

FIG. 3 is a diagram illustrating a pen operation;

FIG. 4 is a diagram illustrating a finger operation;

FIG. 5 is a diagram illustrating operation switching;

FIG. 6 is a flowchart depicting the flow of a process;

FIG. 7 is a diagram illustrating a display example; and

FIG. 8 is a diagram illustrating an example of a hardware configuration.

### DESCRIPTION OF EMBODIMENTS

However, in the above-mentioned technology, when the operation mode is switched, a hand operation such as a button operation is performed every time, so it is not user-friendly. For example, if the screen scaling with user's hand or the character input with a touch pen is repeated frequently, switching the operation mode is particularly troublesome, and causes a further decrease in user-friendliness.

Preferred embodiments will be explained with reference to accompanying drawings. Incidentally, the technology discussed herein is not limited by the embodiments. Furthermore, the embodiments can be appropriately combined within a range which causes no contradiction.

### First Embodiment

Entire Configuration

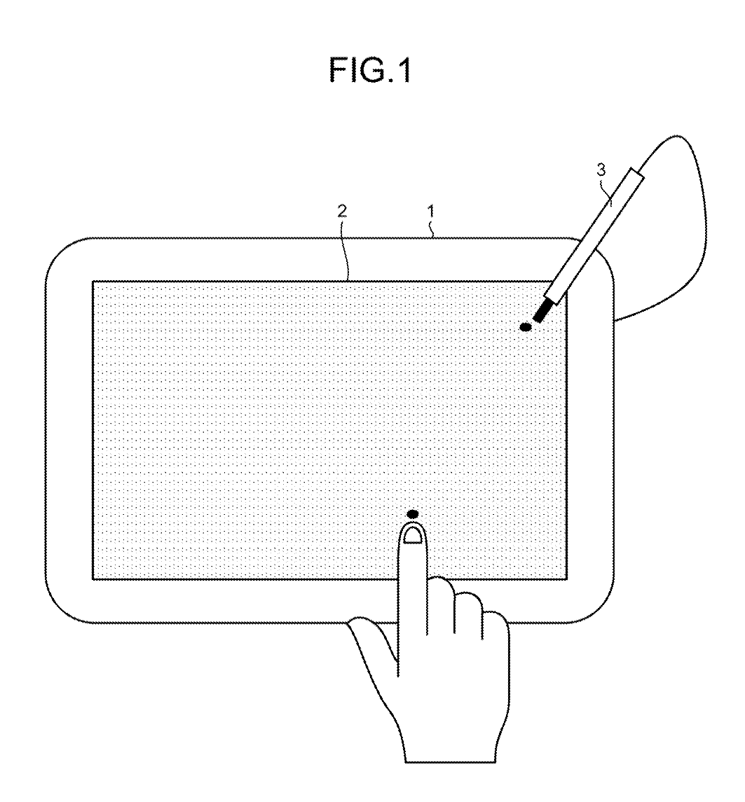

FIG. 1 is a diagram illustrating a tablet terminal according to a first embodiment. A tablet terminal 1 includes a touch panel 2 and an input, device such as a touch pen 3 for manipulating information displayed on the touch panel 2. As the touch panel 2, various types of touch panels, such as a capacitance type, an electromagnetic induction type, and a combination of these two types, can be adopted. This tablet terminal 1 executes a first operation mode with a living body, such as user's finger(s) or palm, and a second operation mode with a touch pen. The first operation mode includes, for example, zoom in or out of information. The second operation mode includes, for example, input of a character.

Incidentally, the tablet terminal 1 can be a stand-alone tablet terminal, or can be a tablet terminal separated from a liquid crystal display (LCD) separation type personal computer or the like. Furthermore, the tablet terminal 1 and the touch pen 3 can be connected by any cable, or can be separated from each other. Moreover, in the present embodiment, there is described an example of a teaching system that displays a Japanese language or arithmetic problem on the touch panel 2 and receives an answer to the problem; however, the technology discussed herein is not limited to this, and can also be applied to other systems using the touch panel 2.

The tablet terminal 1 selects the first operation mode when having detected a living body on the touch panel 2, and selects the second operation mode when having detected the touch pen 3 on the touch panel 2. The tablet terminal 1 performs manipulation of information displayed on the touch panel 2 by using the first or second operation mode.

In this way, the tablet terminal 1 can automatically switch to an appropriate mode in accordance with information detected on the touch panel 2 without receiving a switching operation, such as pressing down a mode switching button. Consequently, the tablet terminal 1 can improve the user-friendliness.

Functional Configuration

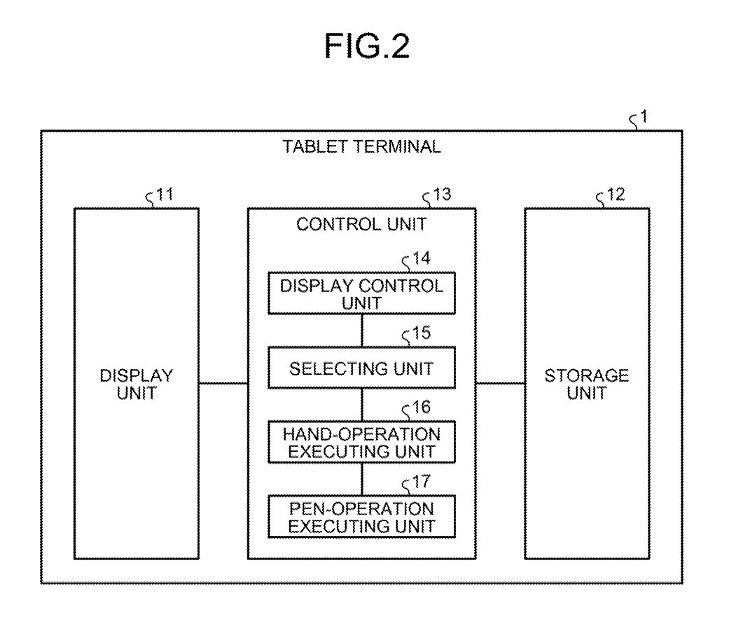

FIG. 2 is a functional block diagram depicting a functional configuration example of the tablet terminal according to the first embodiment. As depicted in FIG. 2, the tablet terminal 1 includes a display unit 11, a storage unit 12, and a control unit 13.

The display unit 11 is a processing unit that displays thereon a variety of information, and corresponds to, for example, the touch panel 2 illustrated in FIG. 1. This display unit 11 displays thereon a problem in, for example, Japanese language or arithmetic. The storage unit 12 is a storage device that stores therein a program executed by the control unit 13 and various data, and is, for example, a memory or a hard disk. This storage unit 12 stores therein, for example, various thresholds, a determination result, data to be displayed, etc.

The control unit 13 is a processing unit that manages the processing by the entire tablet terminal 1, and is, for example, a processor or the like. This control unit 13 includes a display control unit 14, a selecting unit 15, a hand-operation executing unit 16, and a pen-operation executing unit 17. Incidentally, the display control unit 14, the selecting unit 15, the hand-operation executing unit 16, and the pen-operation executing unit 17 are an example of an electronic circuit included in a processor or an example of a process performed by the processor.

The display control unit 14 is a processing unit that displays information on the display unit 11. For example, the display control unit 14 reads out data stored in the storage unit 12, and displays the read data on the display unit 11.

The selecting unit 15 is a processing unit that selects the operating mode of the display unit 11. Specifically, the selecting unit 15 detects user's finger(s) or the touch pen 3 or the like, and selects the operation mode of the touch panel 2 according to a result of the detection. Then, the selecting unit 15 issues an instruction to start a process of the selected operating mode.

For example, when having detected the contact of user's finger(s) on the touch panel 2, the selecting unit 15 selects the first operation mode and instructs the hand-operation executing unit 16 to start processing. Furthermore, when having detected the contact of the touch pen 3 on the touch panel 2, the selecting unit 15 selects the second operation mode and instructs the pen-operation executing unit 17 to start processing. In this way, the selecting unit 15 selects the operation mode according to which has come in contact with the touch panel 2, user's finger(s) or the touch pen 1.

Incidentally, various techniques can be adopted as a technique to determine which has come in contact with the touch panel 2, a living body or the touch pen 3. For example, the selecting unit 15 holds first and second ranges; the first range is a range of values of pressure when the touch panel 2 is operated with the touch pen 3, and the second range is a range of values of pressure when the touch panel 2 is operated with user's finger(s). Then, according to which range a pressure value at the time when the contact has been detected on the touch panel 2 falls into, i.e., according to the writing pressure, the selecting unit 15 identifies which has come in contact with the touch panel 2, a living body or the touch pen 3.

Not only the above-described technique, but other methods can be used to select the operation mode. For example, when an event of the touch pen 3 has been detected on the touch panel 2, the selecting unit 15 can select the second operation mode. Specifically, when the touch pen 3 has been detected within a predetermined range of distance from the touch panel 2, the selecting unit 15 selects the second operation mode. That is, even in a state where the touch pen 3 is not in contact with the touch panel. 2, if the touch panel 2 could detect the touch pen 3 approaching the detectable position, the selecting unit 15 selects the second operation mode.

As a technique to detect the touch pen 3 that is not in contact with the touch panel 2, various existing techniques, existing drivers, etc. can be adopted. For example, if the tablet terminal 1 and the touch pen 3 are connected by any cable, the selecting unit 15 can detect the touch pen 3 by contactless communication with the touch pen 3. As another example, there can be adopted a technique to use, as material of the tip of the touch pen 3, material that the capacitance type touch panel 2 can detect even when the touch pen 3 is not in contact with the touch panel 2.

Furthermore, in the case of the electromagnetic induction type touch panel 2, the selecting unit 15 can detect the contact or approach of the touch pen 3 when the touch panel 2 has detected electromagnetic waves output from the touch pen 3. That is, the selecting unit 15 can detect the approach of the touch pen 3 when having detected micro-electromagnetic waves output from the touch pen 3, even if the touch pen 3 is not in contact with the touch panel 2. In this way, the selecting unit 15 can switch the operation mode according to the presence or absence of electromagnetic waves.

Moreover, the selecting unit 15 can determine whether it is a living body or the touch pen 3 according to the reflection of electromagnetic waves output from the touch panel 2. For example, the selecting unit 15 detects that it is the touch pen 3 if an amount of the reflected electromagnetic waves is equal to or more than its threshold, and detects that it is a living body if an amount of the reflected electromagnetic waves is less than the threshold. That is, the selecting unit 15 detects the reflection of micro-electromagnetic waves output from the touch panel 2, and, if having detected the reflection equal to or more than the threshold, can detect the approach of the touch pen 3.

In this way, when the selecting unit 15 has detected electromagnetic waves equal to or more than its threshold by using any of these techniques, the selecting unit 15 can detect the touch pen 3 that is not in contact with the touch panel 2. Besides these, the selecting unit 15 can determine the contact of a living body if the size of an area of the touch panel 2 where a value of capacitance equal to or more than a threshold has been detected is equal to or more than a predetermined value, and can determine the contact or approach of the touch pen 3 if it is less than the predetermined value. Incidentally, the threshold used here can have a range of values as well.

Furthermore, the selecting unit 15 can prioritize the second operation mode over the first operation mode. For example, if the selecting unit 15 has detected the touch pen 3 on the touch panel 2 after the selecting unit 15 had detected the contact of user's finger(s) on the touch panel 2, the selecting unit 15 can inhibit the first operation mode and switch to the second operation mode. That is, if the selecting unit 15 had detected a living body, such as user's finger(s) or palm, before the selecting unit 15 has detected the touch pen 3, the first operation mode has been selected first but is switched to the second operation mode promptly.

Moreover, when the selecting unit 15 has detected the approach or contact of the touch pen 3 with the touch panel 2, the selecting unit 15 inhibits a change in contents displayed even if having received a swipe operation, pinch-out, or the like to display information on the touch panel 2, and receives input with the touch pen 3. Furthermore, when the approach of the touch pen 3 has been detected, the selecting unit 15 restricts the movement or switching of the display position of a displayed object being displayed on the touch panel 2 according to a predetermined operation. Moreover, when the selecting unit 15 has detected the approach of the touch pen 3, the selecting unit 15 controls so as to prevent the movement of the display position of a displayed object displayed on the touch panel 2 while the touch pen 3 is approaching, even if the selecting unit 15 has detected a swipe operation or the like to move the display position of the displayed object. That is, after the detection of the touch pen 3, the selecting unit 15 restricts a swipe operation or the like of the hand.

The hand-operation executing unit 16 is a processing unit that executes an operation with a living body, such as user's hand or palm. For example, when a double-click, pinch-out, or the like of the hand has been received on the touch panel 2, the hand-operation executing unit 16 executes the zoom in or out of information displayed on the touch panel 2. Furthermore, when a swipe operation or the like has been received on the touch panel 2, the hand-operation executing unit 16 executes the page switching, etc. of information displayed on the touch panel 2.

The pen-operation executing unit 17 is a processing unit that executes various operations with the touch pen 3. For example, the pen-operation executing unit 17 acquires the trajectory of the touch pen 3 on the touch panel 2, and inputs a character in an area where the touch pen 3 followed. Furthermore, for example, when the selection of a Delete button displayed on the touch panel 2 has been received, the pen-operation executing unit 17 deletes character information input in an area pointed with the touch pen 3.

For example, the pen-operation executing unit 17 detects the position of the touch pen 3, and identifies the input trajectory of the touch pen 3 on the basis of multiple positions detected. Then, the pen-operation executing unit 17 executes the display according to the identified input trajectory. Thus, if a user has written a Japanese hiragana character “ [symbol] ” on the touch panel 2 with the touch pen 3, the pen-operation executing unit 17 displays “ [symbol] ” on the touch panel 2; if the user has written an alphabet “A” on the touch panel 2, the pen-operation executing unit 17 displays “A” on the touch panel 2.

Concrete Examples of Various Operations

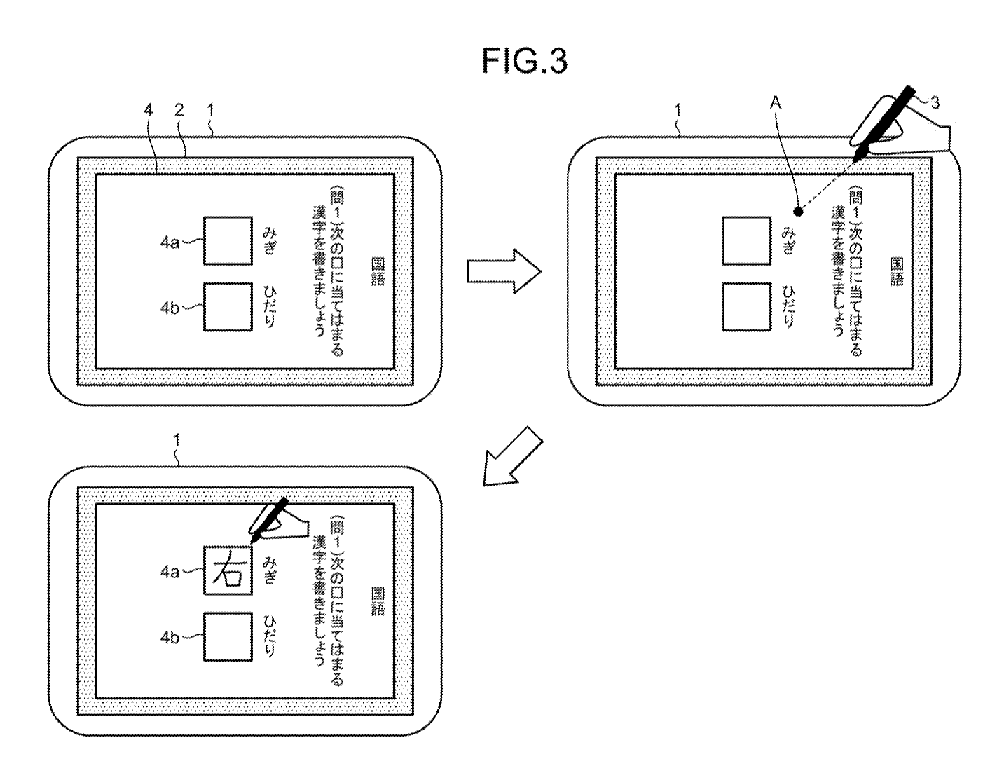

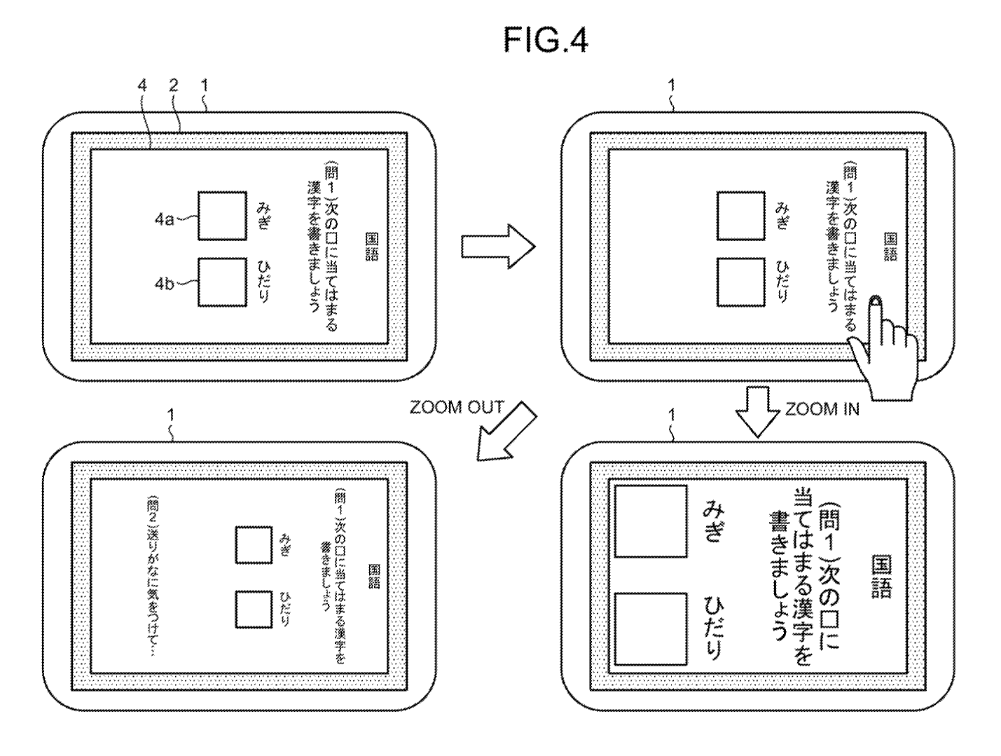

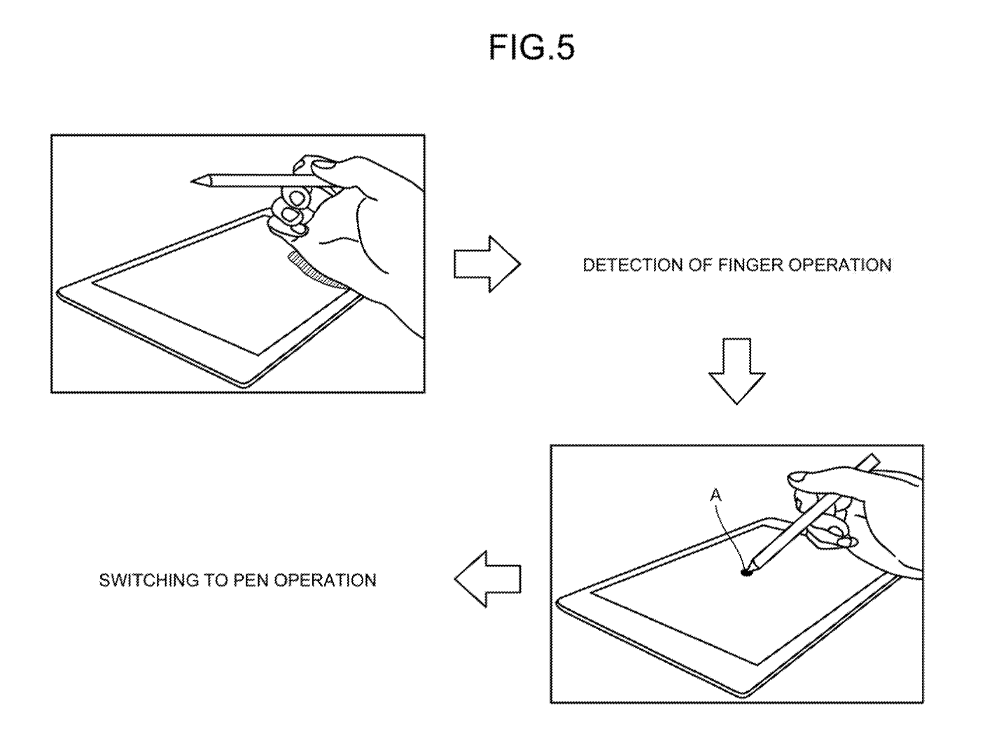

Subsequently, concrete examples of the operation mode selection and various operations are explained with FIGS. 3 to 5. FIG. 3 is a diagram illustrating a pen operation. FIG. 4 is a diagram illustrating a finger operation. FIG. 5 is a diagram illustrating operation switching. In FIGS. 3 to 5, there is illustrated an example where a Japanese language problem 4 including specified areas 4a and 4b, which are answer spaces, is being displayed on the touch panel 2 of the tablet terminal 1.

As illustrated in FIG. 3, in a state where the Japanese language problem 4 including the specified areas 4a and 4b is being displayed, if the selecting unit 15 has detected an event A of the touch pen 3 on the touch panel 2 being in a non-contact state where neither a living body, such as user's finger(s), nor the touch pen 3 is in contact with the touch panel 2, the selecting unit 15 selects the second operation mode into which a pen operation falls. Consequently, the pen-operation executing unit 17 executes the character input to the specified area 4a.

Furthermore, as illustrated in FIG. 4, in the state where the Japanese language problem 4 including the specified areas 4a and 4b is being displayed, if the selecting unit 15 has received only a finger operation, such as a pinch-out, without detecting the touch pen 3, the selecting unit 15 selects the first operation mode into which an operation performed with a living body fails. Consequently, the hand-operation executing unit 16 executes the zoom in or out of the problem 4 displayed on the touch panel 2.

Moreover, as illustrated in FIG. 5, in the state where the Japanese language problem 4 including the specified areas 4a and 4b is being displayed, if the selecting unit 15 has detected the palm of user's hand holding the touch pen 3 on the touch panel 2, the selecting unit 15 selects the first operation mode. However, after that, if the selecting unit 15 has detected the event A of the touch pen 3 on the touch panel 2, the selecting unit 15 switches from the first operation mode to the second operation mode. Thus, a character can be input to the touch panel 2 by a similar operation to the character input to a paper medium.

Flow of Process

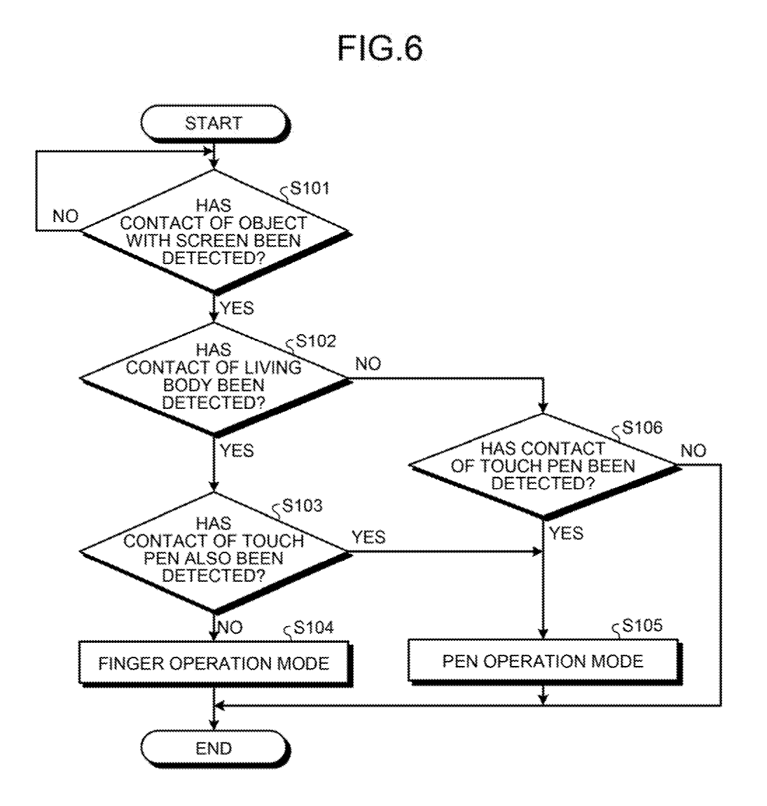

FIG. 6 is a flowchart depicting the flow of a process. As depicted in FIG. 6, if the selecting unit 15 of the tablet terminal 1 has detected contact of an object with the screen of the touch panel 2 (YES at S101), the selecting unit 15 determines whether it is the contact of a living body (S102).

Then, if it is the contact of a living body (YES at S302), the selecting unit 15 further determines whether the selecting unit 15 has also detected contact of the touch pen 3 (S103). If the selecting unit 15 has not detected contact of the touch pen 3 (NO at S103), the selecting unit 15 selects the finger operation mode (S104). On the other hand, if the selecting unit 15 has further detected contact of the touch pen 3 (YES at S103), the selecting unit 15 selects the pen operation mode (S105).

At S102, if the selecting unit 15 has detected not the contact of a living body (NO at S102) but the contact of the touch pen 3 (YES at S106), the selecting unit 15 selects the pen operation mode (S105). On the other hand, if it is neither the contact of a living body (NO at S102) nor the contact of the touch pen 3 (NO at S106), the selecting unit 15 ends the process. For example, the selecting unit 15 can be configured to perform not either the finger operation mode or the pen operation mode but predesignated operations such as the switching of display data and the exit of the display besides.

### Advantageous Effects

As described above, the tablet terminal 1 can switch the operation mode by extending a finger operation or pen operation. Therefore, even when a user repeats the scaling with his/her hand or the character input with a touch pen frequently, the operation mode can be switched without performing a button operation. Consequently, the tablet terminal 1 can improve the user-friendliness.

Furthermore, when the touch pen 3 has been detected within a predetermined range of distance from the touch panel 2, the tablet terminal 1 can select the second operation mode. Therefore, the tablet terminal 1 can quickly detect the touch pen held by user's hand, so it is possible to reduce the time between the contact of the touch pen 3 and the input of a character. Consequently, the tablet terminal 1 can further improve the user-friendliness.

Moreover, when the tablet terminal 1 has detected the approach of the touch pen 3, the tablet terminal 1 prevents the movement of the display position of a displayed object while the touch pen 3 is approaching, even if the tablet terminal 1 has detected a swipe operation or the like to move the display position of the displayed object displayed on the touch panel 2. In this way, the tablet terminal 1 can prioritize the pen operation mode even after the tablet terminal 1 has selected the finger operation mode. Consequently, the selection of the operation mode just as a user intended can be performed automatically and appropriately; therefore, the usability is improved, and the user can input a character to the touch panel 2 of the tablet terminal by performing a similar operation to the character input to a paper medium.

### Second Embodiment

The embodiment of the technology discussed herein is explained above; besides the above-described embodiment, the present technology can be embodied in various different forms.

Display Example

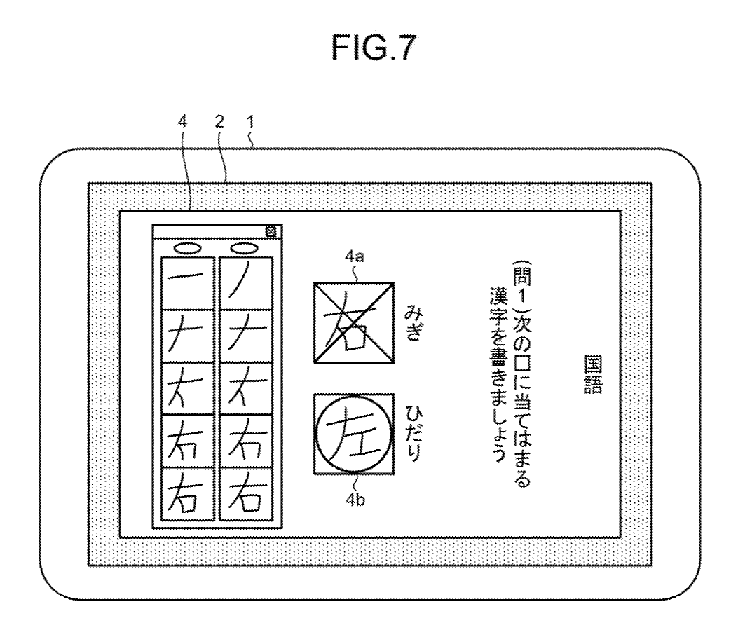

FIG. 7 is a diagram illustrating a display example. As illustrated in FIG. 7, the tablet, terminal 1 receives a user operation, thereby the tablet terminal 1 can display the input stroke order and the correct stroke order on the touch panel 2. If information on such character input is being displayed, the selecting unit 15 can fix the second operation mode. Consequently, the operation mode can be fixed even if the user has released the touch pen 3; therefore, it is possible to perform another operation, such as checking a dictionary, in parallel.

Operation Example

For example, the selecting unit 15 can select the second operation mode if having detected the touch pen 3 within a prespecified area and select the first operation mode if having detected the touch pen 3 outside the area. For example, in the case illustrated in FIG. 3, the selecting unit 15 selects the second operation mode if having detected the touch pen 3 within the specified areas 4a and 4b. Thus, the tablet terminal 1 can reduce the time to switch between the second operation mode and the first operation mode.

Furthermore, when having selected the second operation mode, the selecting unit 15 can maintain the second operation mode until a predetermined time passes since the touch pen 3 has become undetectable. In this case, when a double-click or the like of the touch pen 3 has been detected, the pen-operation executing unit 17 can execute the zoom in or out, etc.

Moreover, when having detected the approach of the touch pen 3, the selecting unit 15 restricts the movement of the display position of a displayed object being displayed on the touch panel 2, or limits the movement of the display position of the displayed object so as to follow an instruction made through a menu. For example, the tablet terminal 1 inhibits an operation with a living body as long as the pen operation mode is selected, but allows an operation on the menu screen of a teaching system or the like. Therefore, the tablet terminal 1 can allow the screen transition or screen scaling made through a menu even during the pen operation mode selected.

In this way, the fixation or switching of the operation mode is determined according to the area in which an operating device is detected or information being displayed, thereby the operation mode can be switched according to information to be displayed or an operation intended by a user. Accordingly, the user operability of the tablet terminal is improved, and the user-friendliness is further improved. Incidentally, in the example described above, the touch pen 3 is cited as an example of an input device; however, the input device is not limited to this, and other devices capable of outputting electromagnetic waves or the like can be adopted.

System

Components illustrated in FIG. 2 do not necessarily have to be physically configured as illustrated in the drawing. That is, the components can be configured to be divided or integrated in arbitrary units. For example, the hand-operation executing unit 16 and the pen-operation executing unit 17 can be integrated into one unit. Furthermore, all or any part of processing functions implemented in each device can be realized by a CPU and a program analyzed and executed by the CPU, or can be realized as hardware by wired logic.

Moreover, out of the processes described in the present embodiments, all or part of the process described as an automatically-performed process can be manually performed. Or, all or part of the process described as a manually-performed process can be automatically performed by a publicly-known method. Besides, the processing procedures, control procedures, specific names, and information including various data and parameters illustrated in the above description and the drawings can be arbitrarily changed unless otherwise specified.

In the above embodiments, the stand-alone tablet terminal 1 is described; besides, a tablet terminal separated from an LCD separation type personal computer or the like can also process in the same way. In this case, either the main body side or the tablet terminal side can perform the above-described process, or both can perform the process in a distributed manner.

Hardware

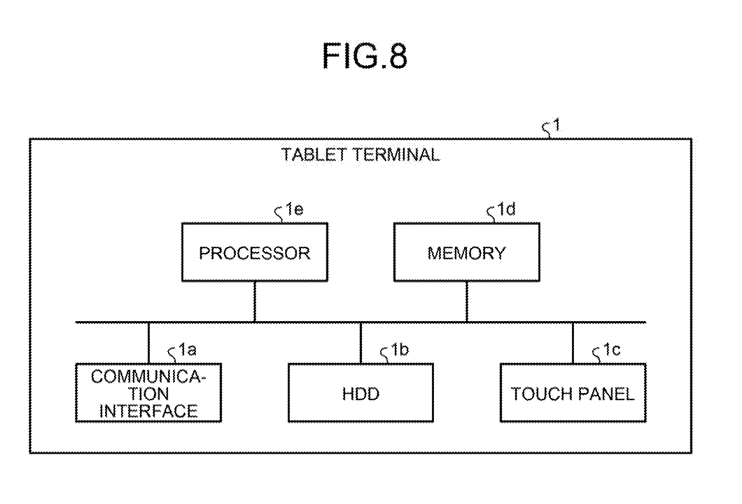

The tablet terminal 1 can be realized by, for example, a computer having a hardware configuration as described below. FIG. 8 is a diagram illustrating an example of the hardware configuration. As illustrated in FIG. 8, the tablet terminal 1 includes a communication interface 1a, a hard disk drive (HDD) 1b, a touch panel 1c, a memory 1d, and a processor 1e.

The communication interface 1a is, for example, a network interface card or the like, and controls communication with another device. The HDD 1b is a storage device that stores therein a variety of information. The touch panel 1c is a display device that displays thereon a variety of information and receives a user operation.

The memory 1d is, for example, a random access memory (RAM) such as a synchronous dynamic random access memory (SDRAM), a read-only memory (ROM), or a flash memory. The processor 1e is, for example, a central processing unit (CPU), a digital signal processor (DSP), a field programmable gate array (FPGA), or a programmable logic device (PLD).

The processor 1e of the tablet terminal 1 operates as an information processing apparatus that reads and executes a program thereby implementing an operation control method. That is, the processor 1e reads a program that executes the same functions as the display control unit 14, the selecting unit 15, the hand-operation executing unit 16, and the pen-operation executing unit 17 from the HDD 1c and expands the read program into the memory 1d. Hereby, the processor 1e can perform a process that executes the same functions as the display control unit 14, the selecting unit 15, the hand-operation executing unit 16, and the pen-operation executing unit 17. Incidentally, the program according to the present embodiment is not limited to be executed by the tablet terminal 1. The technology discussed herein can be also applied to, for example, the case where another computer or a server executes the program and the case where another computer and a server execute the program in cooperation.

This program can be distributed via a network such as the Internet. Furthermore, this program can be recorded on a computer-readable recording medium, such as a hard disk, a flexible disk (FD), a CD-ROM, a magneto-optical disk (MO), or a digital versatile disc (DVD), so that a computer can read the program from the recording medium and execute the read program.

According to the embodiments, it is possible to improve the user-friendliness.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display terminal device comprising:
a processor that executes a process including:
moving a display position of a displayed object or switching a displayed object, according to a predetermined operation performed on a touch panel;
detecting approach of an input device; and
restricting the moving the display position of the displayed object or the switching the displayed object when the approach of the input device is detected at the detecting.

2. The display terminal device according to claim 1, wherein the predetermined operation is a swipe operation.

3. The display terminal device according to claim 1, wherein the predetermined operation is an operation to move a hand holding the input device on the touch panel.

4. The display terminal device according to claim 1, wherein the input, device is a touch pen.

5. The display terminal device according to claim 1, wherein
the detecting includes detecting the approach when size of an area of the touch panel where a value of capacitance equal to or more than a threshold is detected is equal to or less than a predetermined value or when an electromagnetic wave which is output from the input device and detected by the touch panel is equal to or more than a threshold.

6. A display terminal device comprising:
a processor that executes a process including:
in response to the approach of an input device detected by a touch panel, transiting to a mode of receiving input of a character to the touch panel with the input: device without receiving a predetermined operation to move a displayed object with a living body.

7. The display terminal device according to claim 6, wherein
the detecting includes detecting the approach when size of an area of the touch panel where a value of capacitance equal to or more than a threshold is detected is equal to or less than a predetermined value or when an electromagnetic wave which is output from the input device and detected by the touch panel is equal to or more than a threshold.

8. A display control method comprising:
moving a display position of a displayed object or switching a displayed object, according to a predetermined operation performed on a touch panel, using a processor;
detecting approach of an input device, using the processor; and
restricting the moving the display position of the displayed object or the switching the displayed object when the approach of the input device is detected at the detecting, using the processor.

9. A display control method comprising in response to the approach of an input device detected by a touch panel, transiting to a mode of receiving input of a character to the touch panel with the input device without receiving a predetermined operation to move a displayed object with a living body, using a processor.

10. A non-transitory computer-readable recording medium having stored therein a display control program that causes a computer to execute a process comprising:
moving a display position of a displayed object or switching a displayed object, according to a predetermined operation performed on a touch panel;
detecting approach of an input device; and
restricting the moving the display position of the displayed object or the switching the displayed object when the approach of the input device is detected at the detecting.

11. A non-transitory computer-readable recording medium having stored therein a display control program that causes a computer to execute a process comprising:
in response to the approach of an input device detected by a touch panel, transiting to a mode of receiving input of a character to the touch panel with the input device without receiving a predetermined operation to move a displayed object with a living body.
